(19) United States
(12) Patent Application Publication
(10) Pub. No.: US 2018/0110189 A1
(43) Pub. Date: Apr. 26, 2018

(54) HANGING PLANTER BASKET

(71) Applicants: William Loren SMITH, Buena Park, CA (US); Lester Scott JENSEN, Stanton, CA (US)

(72) Inventors: William Loren SMITH, Buena Park, CA (US); Lester Scott JENSEN, Stanton, CA (US)

(21) Appl. No.: 15/793,980

(22) Filed: Oct. 25, 2017

Related U.S. Application Data
(60) Provisional application No. 62/413,274, filed on Oct. 26, 2016.

(51) Int. Cl. A01G 9/02; A47G 7/04; F21V 33/00

(52) U.S. Cl. CPC A01G 9/024; F21V 33/0028; A47G 7/047

(57) ABSTRACT

Disclosed are devices, systems and related methods of employing one or more horticultural planters that are easy to use and maintain, and which provide illumination and/or entertainment services (i.e., music and/or other audio) utilizing one or more individual planter units.

### CROSS-REFERENCE TO RELATED APPLICATIONS

This application claims the benefit of U.S. Provisional Patent Application Ser. No. 62/413,274 entitled “HANGING PLANTER BASKET,” filed Oct. 26, 2016, the disclosure of which is hereby incorporated by reference in its entirety.

### FIELD OF THE INVENTION

The present invention relates to various devices, systems and related methods of employing one or more horticultural planters that are easy to use and maintain, and which provide illumination and/or entertainment services (i.e., music and/or other audio) utilizing one or more individual planter units.

### BACKGROUND OF THE INVENTION

Planters taking the form of hanging baskets are widely utilized by home gardeners, horticultural professionals, business owners and enthusiasts for growing a variety of decorative and other plants. These planters typically include a steel or otherwise rigid basket which forms a generally open circular or semi-circular structure, with the structure suspended from an anchoring point by one or more rods, wires, ropes and/or chains.

One or more plants and/or other display items (i.e., objects d'art and/or faux insects or animals) are typically located within the basket, with the basket typically including a soil or water-retaining mixture that may be contained within a material which allows the passage of air, such as a sphagnum moss or coco matting, which can be utilized to line an open basket structure. The soil or other growing material desirably provides support for the roots of the plantings, along with retention of a desirable amount of water in the area of the plant roots while allowing for air to flow into that same area. However, applying the sphagnum moss or coco matting usually entails taking dried moss, which is brittle and crumbly, and soaking it in water to make it sufficiently pliable to mold it around the interior of the basket, which can be a time consuming and difficult process which often produces inconsistent functional properties of the resultant lining.

In many instances, it would be desirous for one or more planters in a specific location to provide multiple functions in addition to their plant-retaining function (and their associated aesthetically pleasing display thereof). For example, it may be desirous for a planter to also provide illumination to a desired area, which could further complicate the design of the planter as well as require a substantial investment on the part of the homeowner or business owner (i.e., requiring them to invest in an entire new, expensive lighting assembly). In a similar manner, it may be desirous for one or more planters to incorporate speakers or other entertainment-providing functions, which again can greatly increase the complexity and expense associated with the planter design and/or installation.

Another common problem with existing planter designs is the difficulty with ensuring optimal water levels within the planter and preventing water leakage from the planter. Moreover, it is often difficult to replace dead and/or dying plants in an individual planter basket.

### BRIEF SUMMARY OF THE INVENTION

The present invention relates to hanging baskets (including “planter” type baskets) that can incorporate a variety of supplemental and/or modular features, including lamps, switch assemblies, air or watertight compartments and/or various enclosures, including embodiments that may be in various portable and/or non-portable forms. Such baskets and the various components therein: 1) may be associated with, in whole or in part, but are not limited to a floor lamp, table lamp, hanging lamp, wall fixture, desk lamp, boudoir lamp, track lighting system, ceiling light, recessed light, wall light, night light, chandelier and/or various forms of plant receptacle enclosures, urns, vases, figurines (The term “lamp” as used herein and in the claims is meant to include all of the foregoing lighting fixtures and any other lighting fixtures, including, but not limited to fixed (attached) and portable (movable) lighting fixtures, as well as fixed/portable hybrids and convertibles.); 2) may have one or more components with one or more of, but not limited to, the following characteristics: interchangeable, modular, adaptable, telescoping, inter-fastening, interlocking, and/or inter-connecting; and 3) may comprise components to support one or more of, but not limited to, the following functions: lighting, design, wireless communications applications, wireless sensor networking applications, security system applications, monitoring and intervention applications (surveillance, environmental, health and/or safety), home entertainment and sound system applications, a variety of switch activation functions, and other electronics-related applications. One of the primary utilities of the invention is to provide greater function, economic and environmental utility, design and variety for the end user or consumer (residential, commercial or governmental), and also the manufacturer, wholesaler, retailer, direct distribution provider, artisan and/or designer.

At least one embodiment of the present invention is generally directed to a hanging planter basket that incorporates illumination and entertainment devices that avoid or ameliorate many of the drawbacks of the prior art. In various embodiments, a hanging planter basket is provided that is economical to design and manufacture, and which can be utilized alone or can easily be combined with additional baskets to create a multi-basket entertainment installation for areas such as patios, gardens, dining establishments and/or other areas that traditionally incorporate hanging planter baskets.

The present invention also relates to fixtures and/or other features for incorporation into various components of the basket, including at least one interchangeable and/or modular component or components, where any one of the preceding components may: 1) be or be associated with, but not limited to, lighting fixtures, air purifiers, sensors, bar code readers, radio frequency identification (RFID) tag readers, Optical Character Recognition (OCR) readers, dispenser containers, medicine or vitamin pill containers, vases, urns, figurines, sculptures, plant receptacles, flower pot receptacles, umbrella stands, mountings, and/or like containers, fixtures or housings; 2) have one or more components with one or more of, but not limited to, the following characteristics: interchangeable, modular, adaptable, processor-based, software-based, integrated, networked, telescoping, inter-fastening, interlocking, and/or inter-connecting; and 3) may comprise components to support one or more of, but not limited to, the following functions: lighting; medical/health; design; wireless and wire-based communications applications; wireless sensor networking applications; security system applications; monitoring applications (motion detection, surveillance, environmental or health/safety); home entertainment and sound system applications; air freshener and/or aromatic stress relief applications; air purifier, ionizer, and/or smoke filtering applications; insect, bug or pest repellent and/or insecticide applications; electrical outlet power strip applications; electrical cord applications; a variety of switch activation functions, and other electronics-related applications. One of the primary utilities of the invention is to provide greater function, economic and environmental utility, safety, design and variety for the end user or consumer (residential, commercial, hospital, institutional or governmental) with respect to utilizing many of the applications stated in the preceding sentence, and also provide greater function and utility for a variety of constituents or entities associated with the industries represented in the preceding.

### BRIEF DESCRIPTION OF THE SEVERAL VIEWS OF THE DRAWINGS

The foregoing and other objects, aspects, features, and advantages of embodiments will become more apparent and may be better understood by referring to the following description, taken in conjunction with the accompanying drawings, in which:

FIG. 1 depicts an exemplary prior art wire hanging basket;

FIG. 2A depicts a front plan view of one exemplary embodiment of a hanging wire basket constructed in accordance with various teachings of the present invention;

FIG. 2B depicts a front plan view of another exemplary embodiment of a hanging wire basket constructed in accordance with various teachings of the present invention, without an associated upper plant tray;

FIG. 3 depicts an exploded front plan view of the hanging wire basket of FIG. 2A, with various components identified;

FIGS. 4A through 4G depict various views of one exemplary embodiment of a lower housing unit constructed in accordance with various teaching of the present invention;

FIG. 4H depicts an exploded view of another exemplary embodiment of a lower housing unit and associated wire basket constructed in accordance with various teaching of the present invention;

FIGS. 5A through 5F depict various views of one exemplary embodiment of an upper plant tray constructed in accordance with various teaching of the present invention;

FIGS. 6A through 6D depict various views of one embodiment of a wire basket constructed in accordance with various teaching of the present invention;

FIGS. 6E through 6H depict various views of one alternative embodiment of a wire basket constructed in accordance with various teaching of the present invention;

FIG. 7 depicts a front plan of one exemplary embodiment of a hanging wire basket constructed in accordance with various teaching of the present invention;

FIGS. 8A and 8B depict views of various hanging basket embodiments constructed in accordance with various teaching of the present invention; and

FIGS. 9A through 9C depict views of various embodiment of hanging wire baskets incorporating height adjustment and/or lowering components.

### DETAILED DESCRIPTION OF THE INVENTION

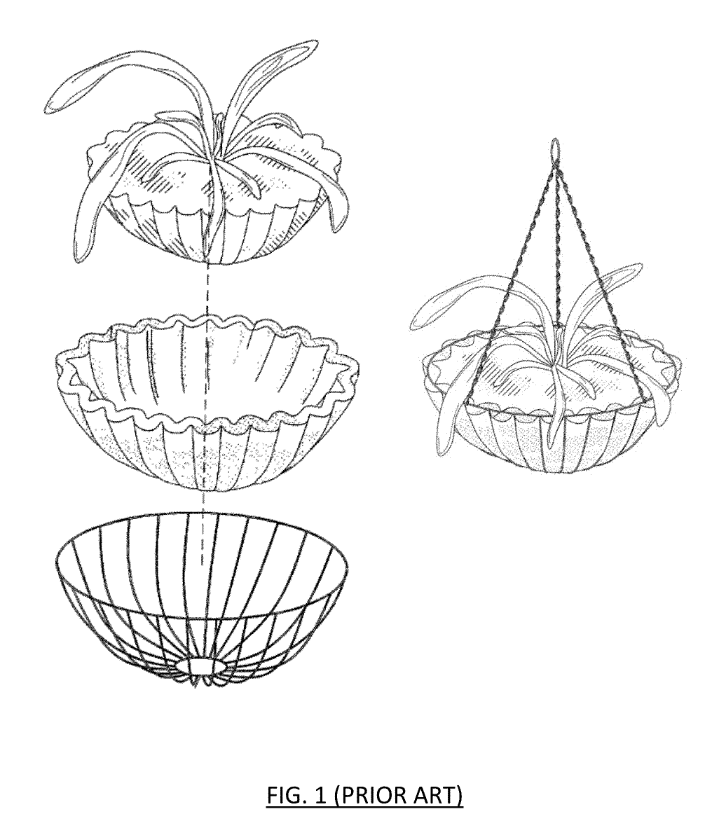

FIG. 1 depicts an exemplary prior art hanging planter basket, wherein a plant and associated soil mixture can be inserted into a concave-shaped container, which in turn fits into a concave bowl-shaped wire basket. A series of support arms or chains (three, in this figure) can be connected at a lower end to various separated portions of a rim of the wire basket, with the upper end of the chains connected to a circular ring, where the ring is typically utilized to hang the basket from a hook or other connector (not shown). Watering and/or feeding of the plant is typically accomplished using a watering spout or hose.

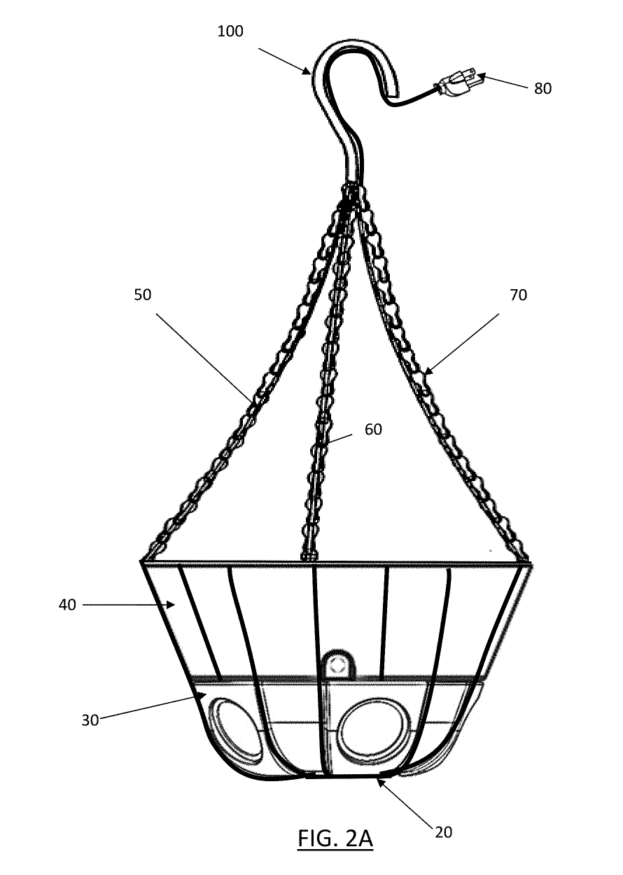

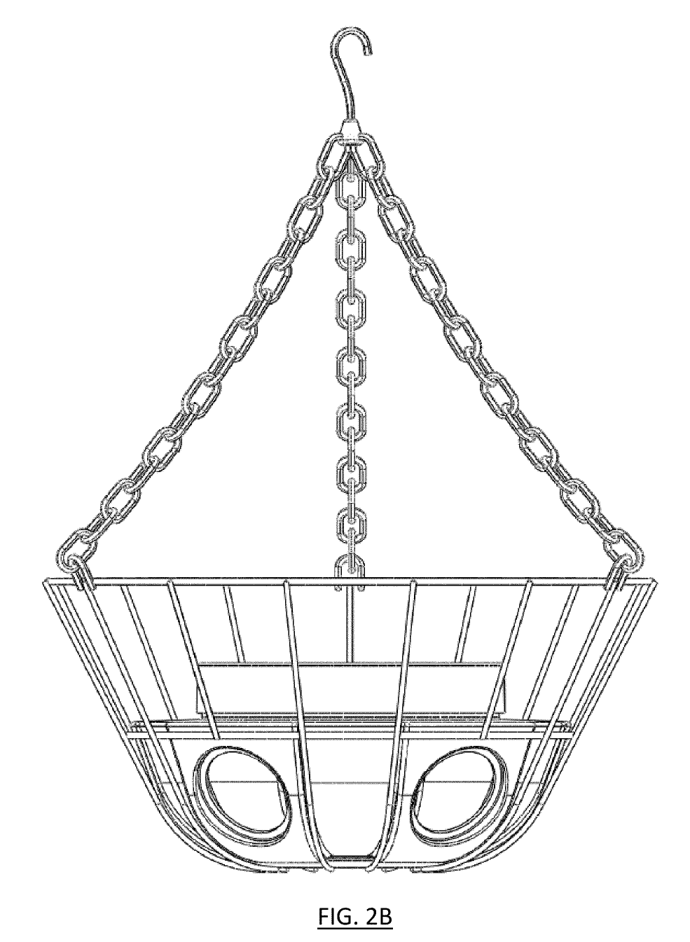

FIG. 2A depicts one exemplary embodiment of a hanging wire basket constructed in accordance with various teachings of the present invention. The hanging wire basket 10 can include a lower wire basket 20, with a lower housing unit 30 and an upper plant or support tray 40 positioned within the wire basket 20. The wire basket can desirably be supported by a series of chains 50, 60 and 70, with at least one of the chains 50, 60, 70 including a power cord 80 threaded through individual links of the chains 50, 60 70. A wrapping or covering (not shown) can be provided on each of the chains 50, 60, 70, which desirably conceals the power cord 80 and provides a pleasing aesthetic appearance to the chains 50, 60, 70. An upper end of the chains 50, 60,70 can desirably be connected to a ring or hook 100.

Lower Housing

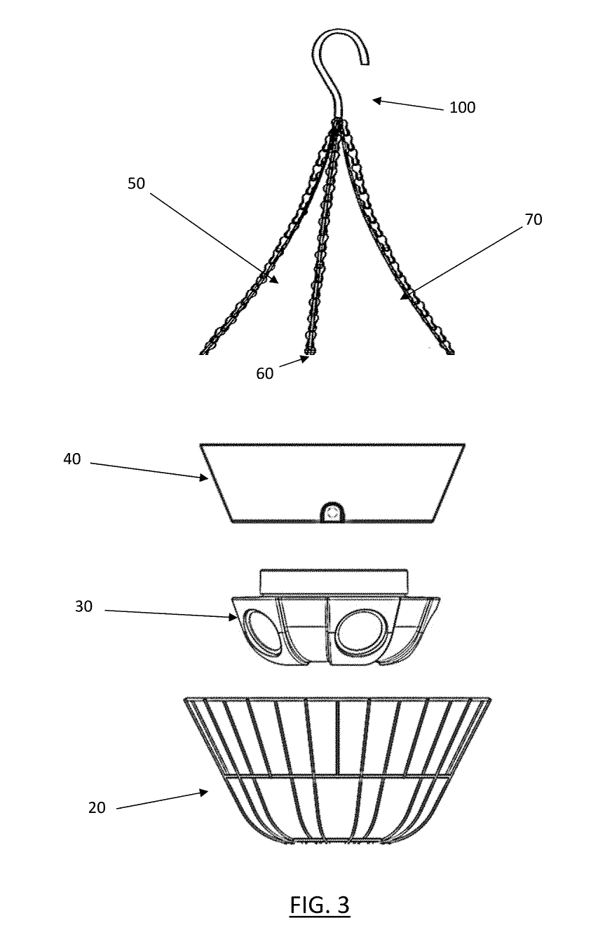

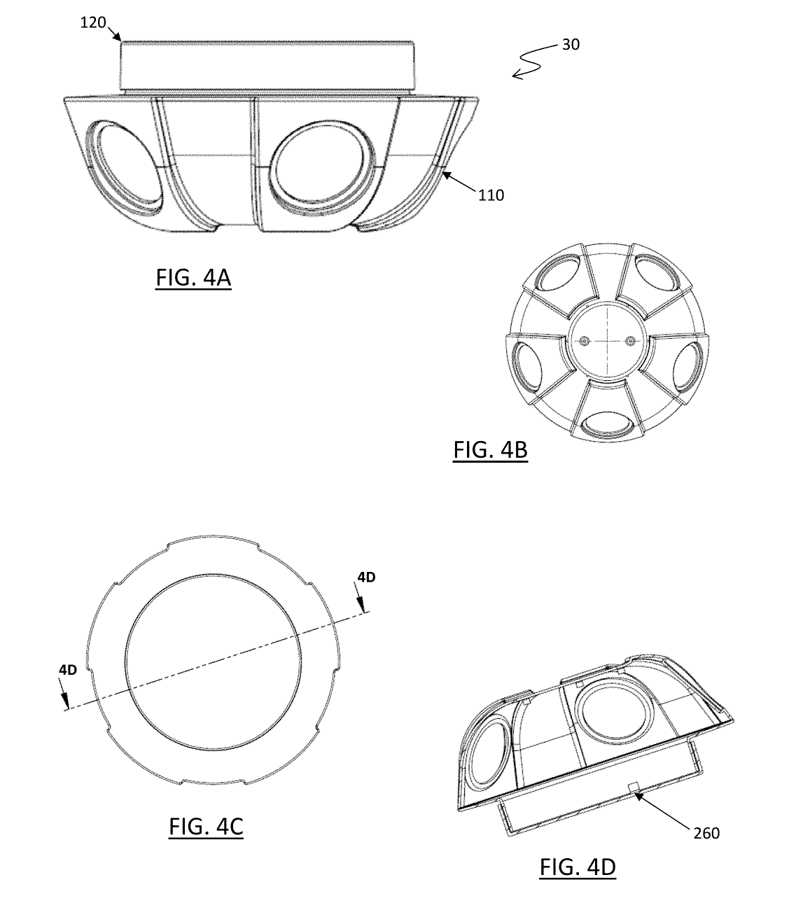

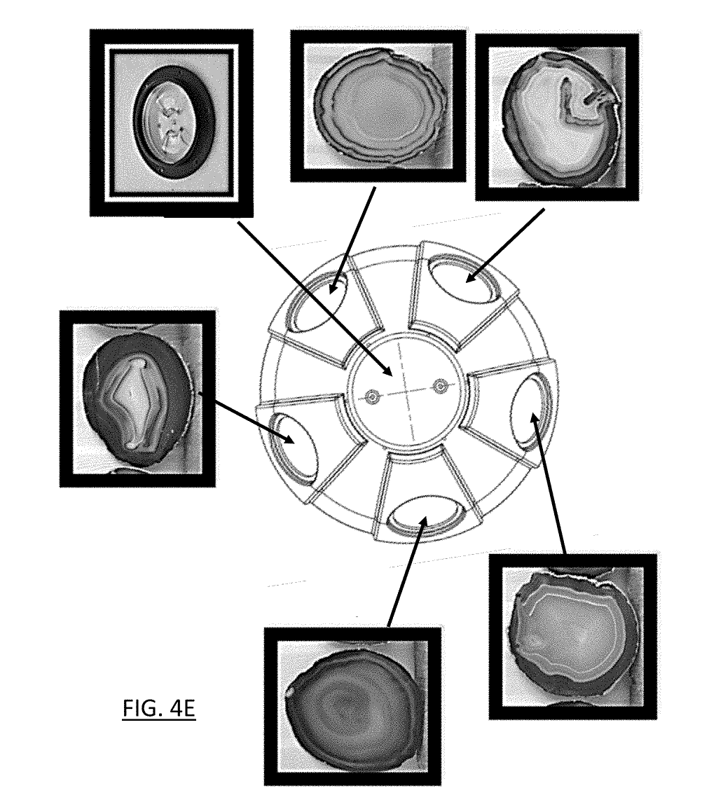

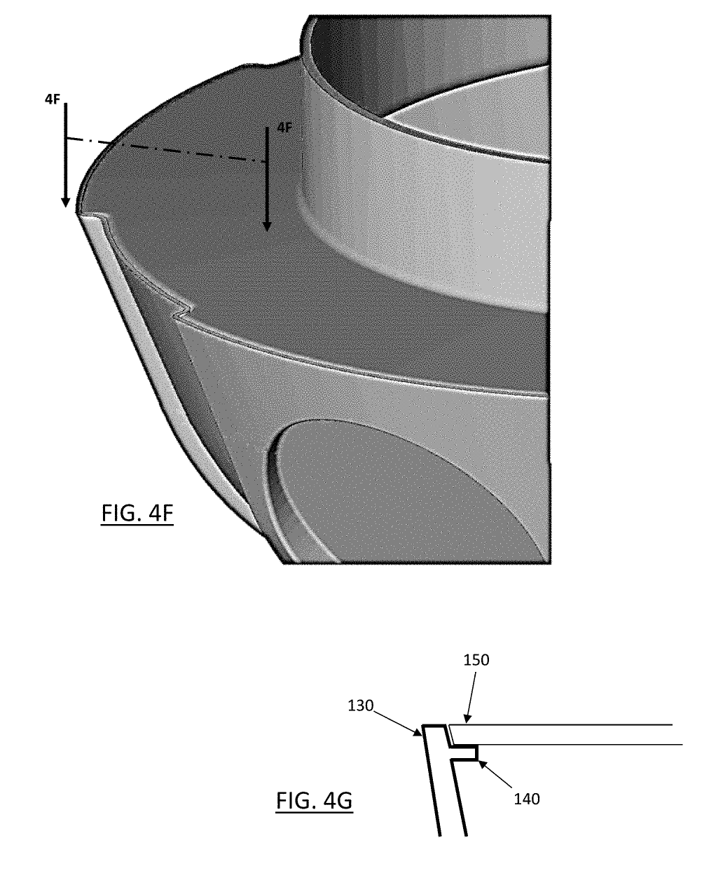

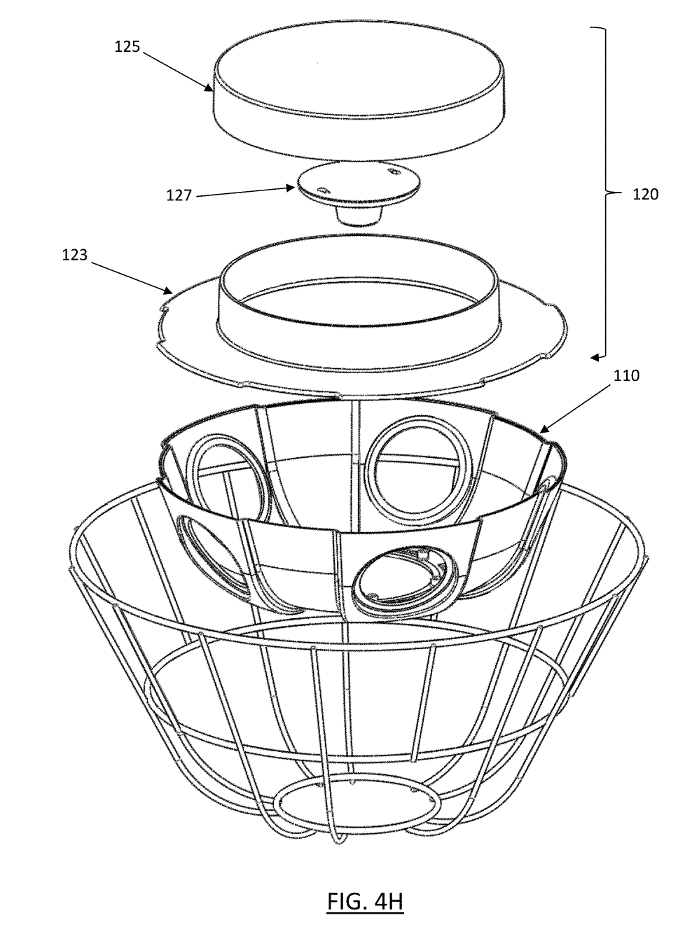

As best seen in FIGS. 4A through 4D and 4H, in one embodiment the lower housing unit 30 will desirably comprise a light basket 110 and an upper shell 120, with the upper shell comprising a shell base 123, a shell cap 125 and a light socket fixture 127 having a screw fitting and/or any other engagement features (and/or electrical or electronic components) disposed therein. The shell base 123 will desirably fit within and engaging with the light basket 110 as best shown in FIGS. 4F and 4G. If desired, a flange 130 and lip 140 can be provided on the light basket 110 that engages with a corresponding edge 150 on the shell base 123, which can be secured by adhesives (i.e., waterproof marine epoxy) or welding (i.e., heat bonding or ultrasonic welding) or other known bonding techniques, or the design could alternatively can include a snap-fit or other engagement arrangement (not shown). Desirably the bond between the light basket 110 and the upper shell 120 will be water proof and/or water-resistant to some degree. In at least one exemplary embodiment, the lower housing unit 30 can be a plastic structure approximately 15 inches in diameter (i.e., side to side) with an approximate height of 6.25 inches. Desirably, the outside diameter of the shell cap 125 will be approximately 10.125 inches in diameter, with the light basket 110 having a relatively flat bottom surface of approximately 6.5 inches in diameter. Desirably, the upper shell 120 portion can be approximately 2 inches in height.

The light basket 110 can comprise a one eighth inch thick Polyethylene curved plastic wall formed using a variety of known manufacturing techniques, including lost wax casting or vacuum and/or blow molding. Desirably, the light basket will comprise an opaque material that inhibits and/or prevents light from passing directly through some or all of the walls of the basket. As best seen in FIGS. 4A, 4B and 4E, the light basket 110 can include a plurality of depressions 160 formed into the lower surface, which in various embodiments can be utilized to accommodate ornamental features such as a series of five to six inch by quarter inch to three sixteenth of inch thick agate pieces, which can be translucent and desirably allow light to pass therethrough. Each of the depressions can be formed sufficiently deep to accommodate a selected thickness of agate or other material, and each depression can include an opening 170 formed therein, which can allow light from a light source (not shown). Each opening can include a peripheral lip 180, which can be utilized to position and secure the agate using adhesive or other securement feature. Desirably, light passing through the one or more agates or other ornamental features will illuminate an area below and/or around the area where the planter is positioned. In at least one alternative embodiment, the light basket 110 could alternatively include flush openings to accommodate the agates or other ornamental features, which could lessen and/or obviate the need for sizing the agates to accommodate a depression.

In alternative embodiments, one of more of the depressions could be utilized to accommodate a variety of modular components in place of an/or in addition to the described ornamental features (i.e., agates), including additional lighting and/or sound producing components, if desired.

A screw-type hatch 190 (or other securement such as a snap-lip or screw secured hatch) can be provided in a lower surface of the light basket 110. Desirably, the hatch 190 can be opened to expose a hole of approximately 4.5 inches in diameter (not shown) through which a light source (not shown) contained within the light basket can be accessed, desirably allowing for repair, required maintenance and/or bulb replacement as necessary. If desired, the hatch 190 can comprise a transparent or translucent material (or some portions thereof), which could allow light to pass therethrough and illuminate an area below the planter. In various embodiments, the hole can comprise a four-inch hole with the hatch 190 made of a 5.75 inch diameter disc of polypropylene, which can allow light to come out the bottom of the light basket 110, and gives access to change out the light bulb or other components. If desired, the bottom structure of the light basket could alternatively be thickened to varying degrees (i.e., from between 0.150 inches to 0.5 inches or thicker) to strengthen the structure around the 4.5 inch hole and/or to accommodate securement devices such as screws therethrough, for securing the hatch.

In this embodiment, the opening on the bottom of the wire basket desirably allows the hatch 190 to be opened without disturbing the upper tray, plants and/or soil and/or requiring removal of the basket from its hanging location, facilitating replacement of a blown light bulb or other modular components. In addition, because the hatch is desirably translucent and/or transparent, this arrangement desirably allows the electrical components to be isolated from the outside environment, while concurrently allowing the multicolored light to shine through the bottom.

Planter and/or Support Tray

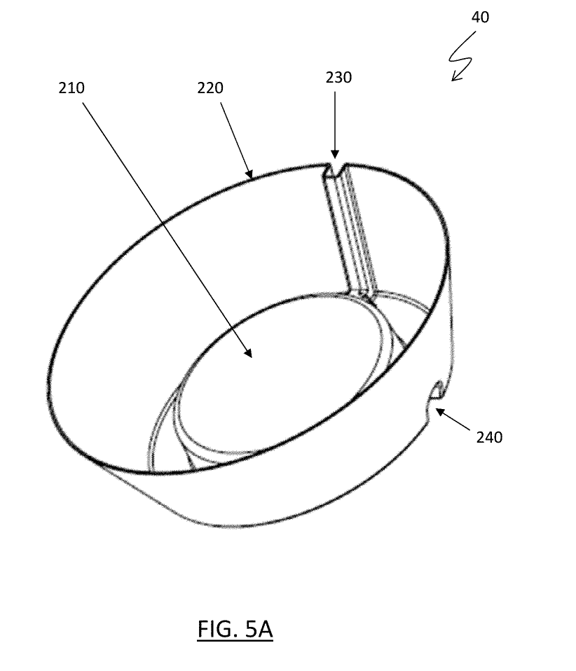

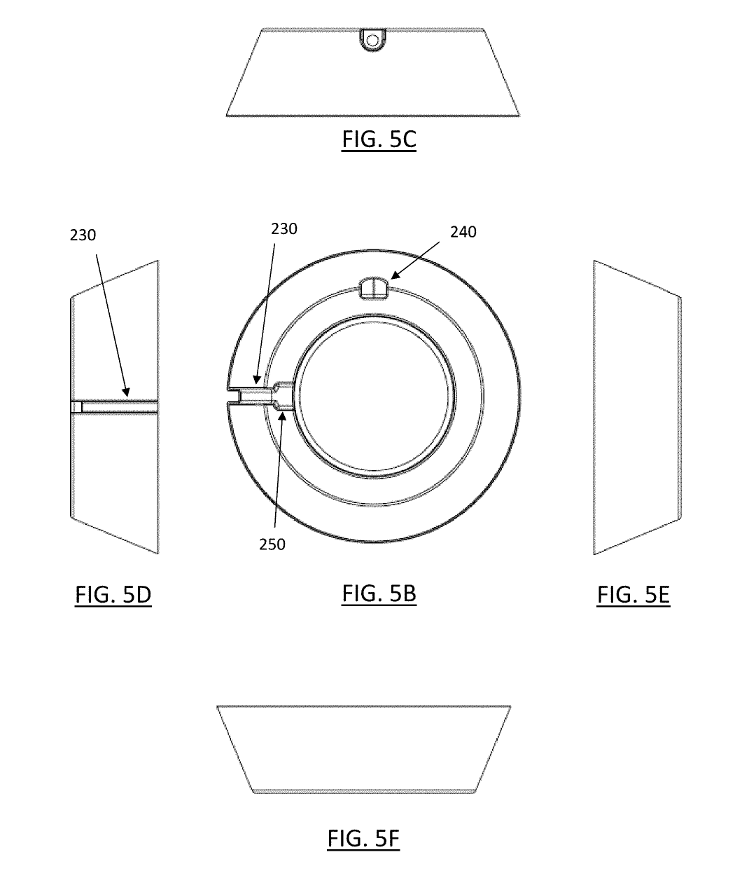

FIG. 5A depicts a perspective view of one exemplary embodiment of an upper plant tray 40, which includes a central raised platform 210 and a peripheral raised wall 220, with the wall 220 including a first notched section 230 and a second notched section 240. Desirably, the raised platform 210 is sized and configured to fit over and engage with the shell cap 125 of the upper shell 120 of the light basket 110, which in one embodiment can comprise an inner diameter (as viewed from the bottom of the plant tray) of approximately 10.825 inches. The peripheral raised wall 220 desirably contains and protects the plant and any related growing medium (i.e., potting soil, coco matting, etc.), and also provides a watertight container for water and/or fertilizer mixtures. The upper plant tray can comprise a plastic tray (i.e., acrylonitrile butadiene styrene, or ABS plastic), with an approximate height of 6.25 inches and an inner diameter (measuring at the top of the plant tray) of approximately 20 inches.

As best seen in FIGS. 5A and 5D, the upper plant tray can include a first notched or grooved section 230, which can accommodate and/or “hide” the power conduit or wire (i.e., a 16/3 gauge wire) as it travels from the roped up chain to the lower housing unit. At the bottom of this notched section 230 where the wire turns to go towards the entrance to the lower housing unit (see FIG. 5B), there can be a slightly enlarged nook 250 which can be sized and configured to accommodate a non-metallic strain relief connector (not shown), which also allows the upper plant tray to sit flush onto the light basket 110. In addition, a relief valve or other arrangement can be provided in the second notched section 240 of the upper plant tray 40, which when opened will desirably allow for excess water or other fluids to pass out of the upper plant tray 40.

In various embodiments, the incorporation of a separate plant tray can resolve various deficiencies of prior art designs, including (1) hiding the growing medium and/or improving the aesthetic appearance of the coco matting, (2) preventing any water and/or small amounts of potting soil from seeping out of the coco matting and/or (3) preventing water rivulets from flowing out of the planter (potentially dropping on patrons below) as well as preventing electrical shorting of components and/or mineral deposits from being left behind on the planter surfaces, which can be quite dangerous and/or greatly detracted from the look of cleanliness. The plant tray can also allow for collection and/or recycling of excess water from the tray after field saturation has been achieved in the growing medium, and can even allow for water distribution to multiple planters of similar design, as will be described later.

In various embodiments, the relief valve can comprise a quarter inch by one eighth inch lead-free brass compression by MPT angle needle valve, which can be inserted into the plant tray by drilling a hole three-eighths of an inch in diameter, and screwing the needle valve through the hole. On the back side of the needle valve, a compression nut can be utilized to ensure that the needle valve will not come out of the tray. Alternatively, a closable plastic valve (similar to an inflatable beach ball or pool float valve, for example) can be utilized. If desired, a piece of polyethylene clear tubing (a six foot section of quarter inch outside diameter tubing, for example) can be inserted into and/or otherwise connected to the valve to direct any excess water to wherever it is wanted and/or to be recycled.

Wire Basket and Chains

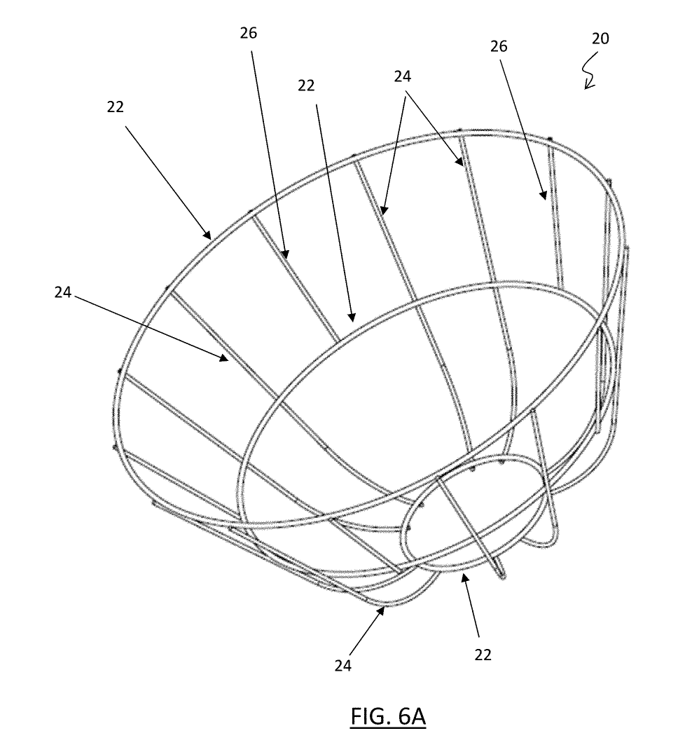

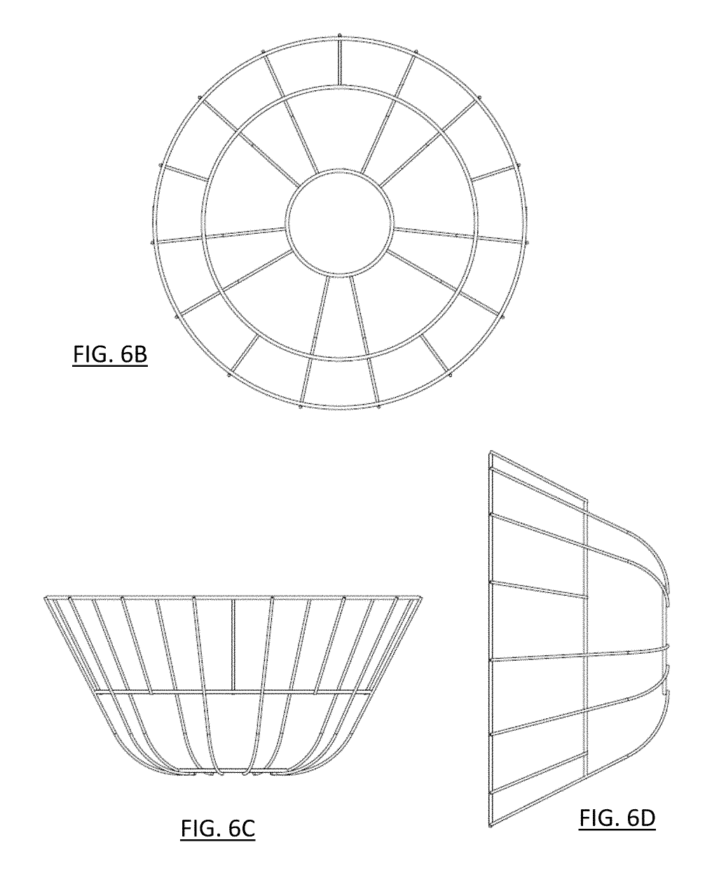

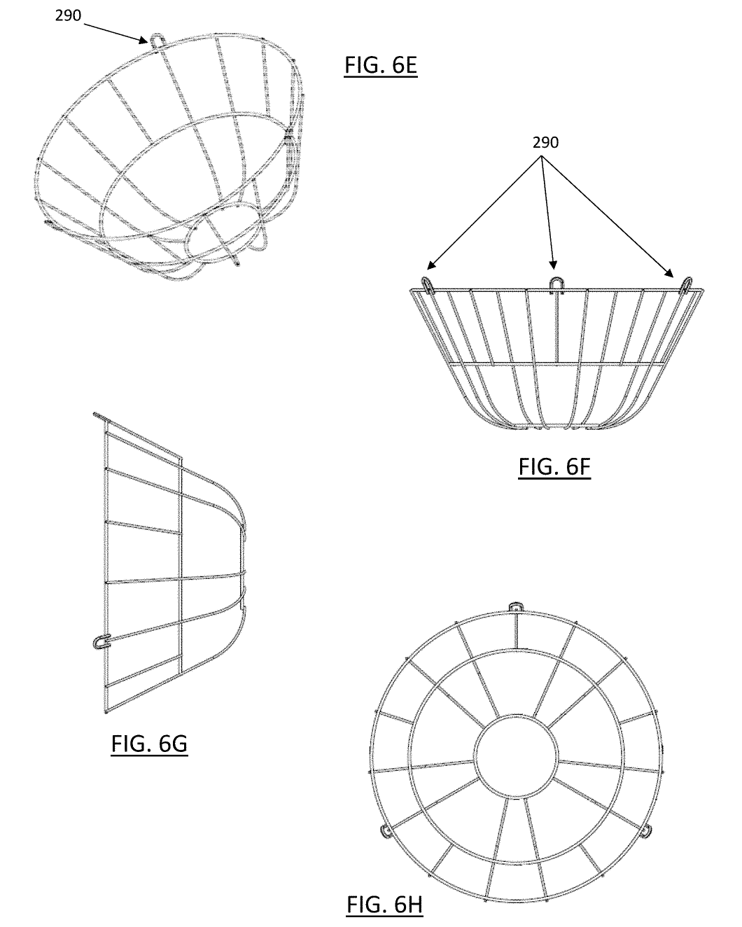

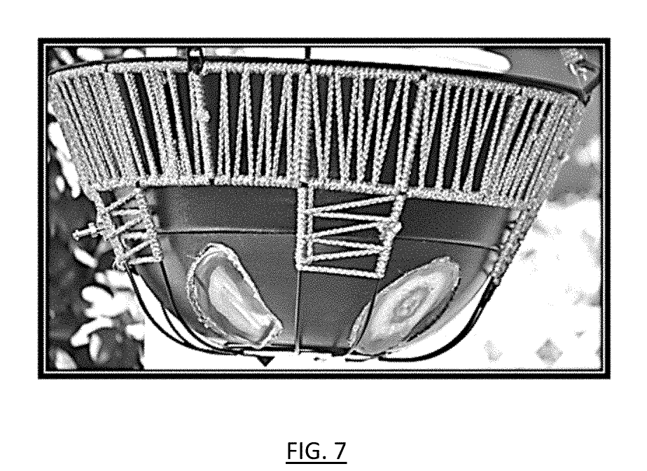

In various embodiments, a wire basket 20 is provided, which may be of any desired size and preferably constructed of non-corrosive metal wire. The basket 20, shown in FIGS. 6A through 6D, can be formed in one or more sections, but desirably includes an open top with a plurality of concentric horizontal bars 22 and a series of vertical curved bars 24 attached thereto. In addition, a plurality of upper strut bars 26 is provided between the upper and middle horizontal bars 22 to provide added strength to the basket. In one exemplary embodiment, the horizontal bars of the basket 20 can comprise metallic wires of thirteen sixty-fourths inches in diameter, with the vertical bars and upper strut bars comprising metallic wires of five thirty-seconds inches in diameter, with each of the bars welded together at various crossing points, and with five openings in the basket provided to allow for the placement of the agates without being hindered by a vertical wire. An upper opening of the basket can be approximately 20 and three-eighths inches in diameter, with a lower opening of approximately 6 inches in diameter.

In various embodiments, a plurality of chains can be attached to an upper bar of the basket in a known manner, or an alternative embodiment (shown in FIGS. 6E through 6H) can include a series of loops 290 attached and/or welded to the wire basket. If desired, three such loops 290 could be provided, with each loop approximately 0.75 inches tall by 0.375 inches wide and connected directly to an upper horizontal bar of the basket, which can accommodate a series of attachment hooks or carabiners.

A wide variety of chains or other support arrangement could be provided to support the wire basket and associated components, but in at least one exemplary embodiment a series of three lengths of Everbilt #135 Zing-Plated Handy Link Chain are utilized (commercially available from Home Depot of Atlanta, Ga., USA). This type of welded chain can include steel and zinc-plated finishes for good weather resistance, and can accommodate a weight capacity of 340 pounds with a weight per foot of only 0.13 pounds. The hardware used to attach the chain work to the hooks can include a general use carabiner, which can be spring loaded bright aluminum, of three inch length, with a working load of 150 lb, or could alternatively be a zinc plated quick link, one and five eight's inches long, outside diameter, by five eight's width outside diameter, with an inside diameter of one and five thirty second inches, by thirteen thirty seconds inside diameter, and a working load of 220 lbs.

Desirably, a power cable can be threaded through one of the individual chains. By bringing in a power source along a chain and then wrapping the chain (and the other support chains) with a covering, the resulting design is desirably less conspicuous when compared to the other two chains supporting the basket, yet allows power to be easily connected to the basket proximate to the hanging location. The three chains can be wrapped, braided and/or plaited with rope to make the appearance of the chains consistent across all three chains (i.e., look the same in height, width, length), including the chain with the 16/3 gauge wire snaking therethrough. The outside length of each link in at least one desired embodiment is one and five eight's inches long, the inside length is one and twenty fifth by sixty fourths inches; while the outside width is five eights, while the inside width is eleven thirty seconds of an inch. Using eighteen of these links, a 16/3 gauge wire can be cut to twelve feet in length. Approximately three feet of the wire can be woven through the links, so enough wire is exposed on the end to be used in the lower housing unit. After the 16/3 gauge wire is snaked through, the chain is roped up. Because the opening in each link of the chain has a rather large opening and width, the wire desirably does not protrude is any manner to significantly deform the roping of the chain; therefore each 18 link chain looks the same when roped up. The chain can be roped with diamond braded polypropylene rope three sixteenth of an inch thick, which can comprise Everbilt polypropylene rope (commercially available from Home Depot of Atlanta, Ga., USA). Desirably, the basket may also be woven with rope in various locations to acquire a beautiful hand-woven look, with any exposed electrical wire connections concealed beneath the rope (See FIG. 7). In various embodiments, single or multi-colored rope can be wrapped around the metal basket to add color and detail to the ensemble, such as red, blue, green, and/or brown colored rope.

Power Supply

In various embodiments, an external power supply can be provided to the powered features of the planter, although in alternative embodiments broadcast power, internal power, solar power and/or batteries could be provided. While a variety of power sources could be utilized to power various components of the disclosed embodiments, in at least two exemplary embodiments, high voltage and/or low voltage power can be supplied to various components, including various combinations thereof to various components in a single planter.

For example, a lower voltage, 12-volt direct current power supply could be provided, or a higher voltage or “standard,” 110-volt alternating current power supply could be provided. In various embodiments, a 110 AC power source could provide sufficient power to illuminate the agates and/or provide other illumination in a desired manner. For this embodiment, a 16/3 Gauge wire can be connected at one end to a lamp holder or other feature that can be installed in the middle of the upper shell 120 of the lower housing unit 30. The lamp holder could comprise a 4-inch diameter twist lock mount, which could be UL listed.

As best seen in FIG. 4D, the lower housing unit 30 could include an opening 260 (i.e., a seven-eighths inch hole) in the body to accommodate passage of the wire inside of the lower housing unit. Desirably, a non-metallic strain relief cord connector could be positioned appropriately to prevent the 16/3 gauge wire going into the basket from being pulled out. Once the wire is secured by the non-metallic strain relief connector, the opening 260 could be filled with a hot glue to prevent any water seeping into the lower housing unit 30.

Desirably, a ground protection system can be provided for higher voltage power systems, which can include a 125-volt Double Pole 3-wire grounding plug gauge wire, with the grounding wire pulled back through the non-metallic strain relief connector and connected to the basket via a crimp on a female spade connector (for a 10-12 gauge wire) that is placed on the basket while the “crimp on male spade disconnector” could be used for the grounding wire from the 16/3 gauge wire. Grounding the basket can significantly increase protection for nearby individuals and maintenance personnel, and pulling the grounding wire out through the strain relief connector and connecting it to the basket with a grounding attachment desirably allows for quick disconnect of the relevant wiring if the basket needed to be disassembled for any reason. In a least one alternative embodiment, the wire could be connected using a 3 pin water tight connector, so if there were any issues with the unit not working or a part is damaged in shipping, the items could be disconnected without having to return the whole unit. In such an embodiment, the wire could comprise a 14 gauge wire with a soldered butt splice to 14 gauge extension wire.

In various embodiments, a 16 amp on/off LED illuminated round hole rocker switch can be incorporated into the lower housing, which could provide an additional indication and/or method of securing power in the planter before servicing the unit, including safely changing the light bulb and/or other components as needed.

Modular Lighting Components

In various embodiments, a light or other illumination source can be provided in various locations of the planter, including within the light basket 110. For example, a standard plastic light socket fixture 127 (see FIG. 4H) or similar device could be positioned within the light basket, with the power supply wires encased in hot glue or other materials to desirably prevent condensation and/or movement. Alternatively, a solid state lighting apparatus such as one or more LED light sources could be permanently mounted within the light basket 110, although replaceable bulb components may be desirably for a variety of reasons. In various embodiments, a fixture such as a light socket fixture 127 or other electronical component can be secured to the shell cap 125 of the light basket 110, if desired.

In various embodiments, the light basket 110 could incorporate additional modular components, such as speakers and/or microphones, which in various embodiments could include detachable modular connections within the lower housing unit 30. In as least one exemplary embodiment, the light basket 110 could incorporate a Bluetooth-enabled speaker lightbulb (commercially available from Sony Corp of Japan) or the Excelvan A65 7W Bluetooth Music LED Bulb (commercially available from AMAZON Corp of Seattle, Wash., USA), or the Audiopho E27 LED Bluetooth Speaker Bulb, which could include dimmable multicolored changing LED lights that potentially enhance the look of the agates to be used in the lower housing unit 30.

Various embodiments herein can include the optional incorporation of modular components such as additional power plugs and/or communications linkages (i.e., ethernet cable, etc.), as well as various features of the planter basket that can be replaced and/or interchanged with alternative features. For example, the lighting fixture (i.e., the Edison screw or other type of bulb socket), the switch assemblies and/or the various enclosure components described herein can be adapted with one or more interconnecting, interlocking or inter-fastening component(s) to allow for lighting fixture, switch assembly and/or enclosure component modification or replacement. The modifications for such lighting fixture and components may allow for greater lighting and design utility, as well as other utilities and applications (non-lighting) that may be advantaged by one or more of the following characteristics: the prevalence and location in most interior and surrounding exterior living and working spaces; greater economy, design and function from utilizing the lighting fixture's structure and associated power source(s); and utilizing decorative and functional enclosures and related interconnected components that may be redeployed for the same or other utilities. In addition, the decorative and functional enclosures contemplated in this invention may also apply solely to plant containers and/or receptacle enclosures where such enclosures may provide support for one or more of the following: supporting a variety of alternative designs, components and/or materials that are not as optimally supported in prior art; allowing for convenient attachment and/or detachment of the plant system (i.e., the plant and/or plant receptacle) to and from the enclosure; and may also allow for interconnected and interchangeable components such as, but not limited to, drainage and/or water supply tubing and/or pully systems/enclosure rings that facilitate access to plants and plant care, as well as changing various aspects of the enclosure configuration without the need to replace the entire configuration.

If desired, the various electronic components described herein could include modular components that allow for alteration of the power supply type and/or amount, including the alteration of the 110-volt AC power supply for an internal 5-volt or 12-volt DC power supply—potentially allowing for off-grid usage as well as less or no pressing need for continuous supply of external power via an external cord, which may be removable from the planter basket. In such embodiments, a replaceable and/or rechargeable battery pack may be provided having a screw-type fitting that possibly fits within the bulb socket of the planter (and which optionally may include a light source on its lower surface), and which provides sufficient power for the various features described herein.

The light bulb fixture (or similar powered fixture, which may not include a light source in various alternative embodiments) can include a variety of features, such as a multi-color LED light bulb, which can include Bluetooth connectivity, potentially including a speaker for providing music, controlling light colors and/or illumination and/or other features. In at least one alternative embodiment, a plurality of hanging baskets could be provided in a single venue (i.e., within a restaurant or along a sidewalk) that incorporate features allowing for networking and/or synchronizing of powered features in the plurality of devices, such as the Bluetooth LED bulb and/or integrated speakers, allowing the baskets to provide coordinated services such as lighting, light shows and/or mood lighting, as well as sound (i.e., single and/or multi-channel sound).

Coordinated Systems and Personalized Entertainment Experiences

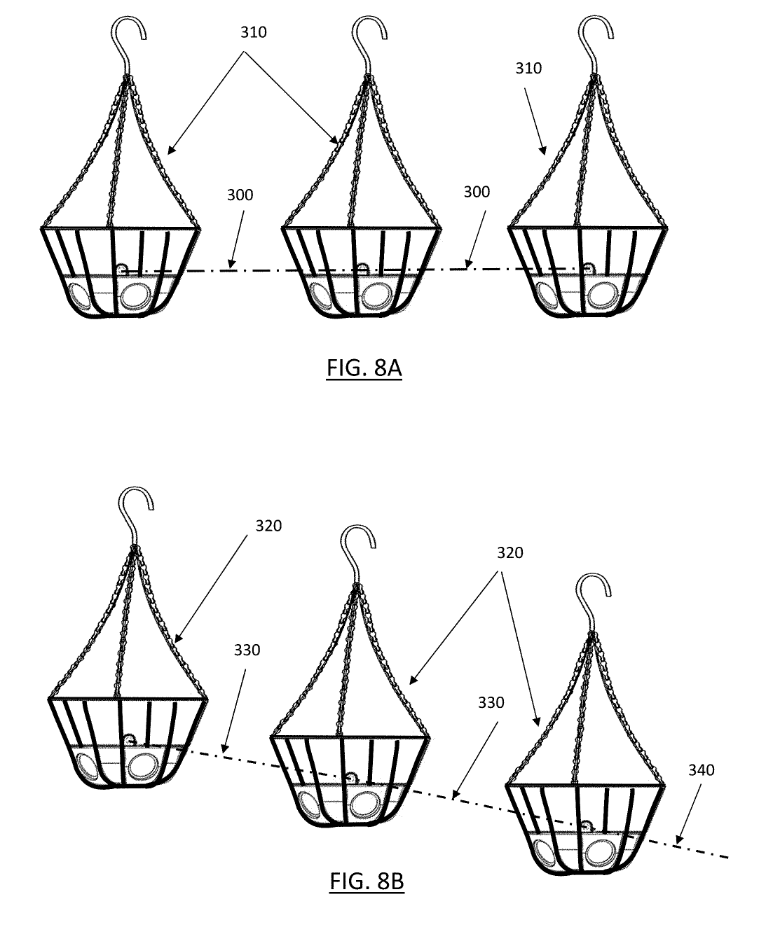

FIG. 8A depicts one exemplary embodiment of a planter system incorporating a plurality of hanging planters of the present invention, with a series of water tubes 300 extending between individual planter baskets 310. In this embodiment, the planter baskets can be watered by simply providing a sufficient amount of water to one basket, which will desirably distribute water to the other baskets via gravity feed through the water tubes 300, with a final level of water in each of the planter baskets being relatively evenly distributed (depending upon individual basket height and placement). FIG. 8B depicts an alternative arrangement of hanging planters 320 in a second planter system embodiment with associated water tubes 330, wherein the planters can also be watered providing a sufficient amount of water to one basket of the present invention, but in this embodiment only the baskets lower than the watered basket will receive additional water, with a drain tube 340 allowing excess water to drain out of the system. In this arrangement, certain plants can desirably receive less water, while others receive more using a single system.

In various embodiments, a plurality of hanging planter baskets can be installed that incorporate illumination and/or entertainment devices allowing for networking or intra-planter coordination in an economical and easy-to-use design and manufacture, which can be utilized alone or can easily be combined with additional baskets to create a multi-basket entertainment installation for areas such as patios, gardens, dining establishments and/or other areas that traditionally incorporate hanging planter baskets. In at least one exemplary embodiment, hanging planter baskets can include wi-fi antennae and/or wi-fi repeaters to provide wireless service to patrons in a convenient and unobtrusive manner. In at least one alternative embodiment, the various planter baskets could incorporate Bluetooth enabled technology that allows patrons to individually alter their local entertainment, such as by connecting their smart-phone with an individual planter speaker (i.e., via Bluetooth) and providing a desired music or other entertainment feature (i.e., sports programming) without disturbing nearby patrons (who may be using their own portable devices to alter their local entertainment).

One significant advantage in various embodiments of the present invention is to utilize the numerous functions that are available from a variety of electronics (including, but not limited to switches, processor-based and/or electrically powered) and communications products in a more adaptable, integrated and enhanced means with new utilities without the need for purchasing such products in an integrated system all at once or cluttering the living and work space with such items when purchased incrementally in standalone form. One of the means for providing such utilities is to incorporate such numerous functions in systems comprising at least one or more components adapted for being comprised, integrated, networked or connected of, in or with other components, fixtures, appliances, dispensers, enclosures, cabinetry, pedestals and bases or be integrated or networked with other such systems with the parts, materials and characteristics described herein. Advantageously, various embodiments herein can include one or more components capable of interconnecting, integrating, networking, interlocking and/or inter-fastening with associated electrical, communications (such as, but not limited to, Wi-Fi and/or Bluetooth communications), data interface and/or circuitry connections (such as, but not limited to, USB for certain data and networked connections), as appropriate, to support interaction (in a variety of forms), modification, upgrade or sub-component replacement.

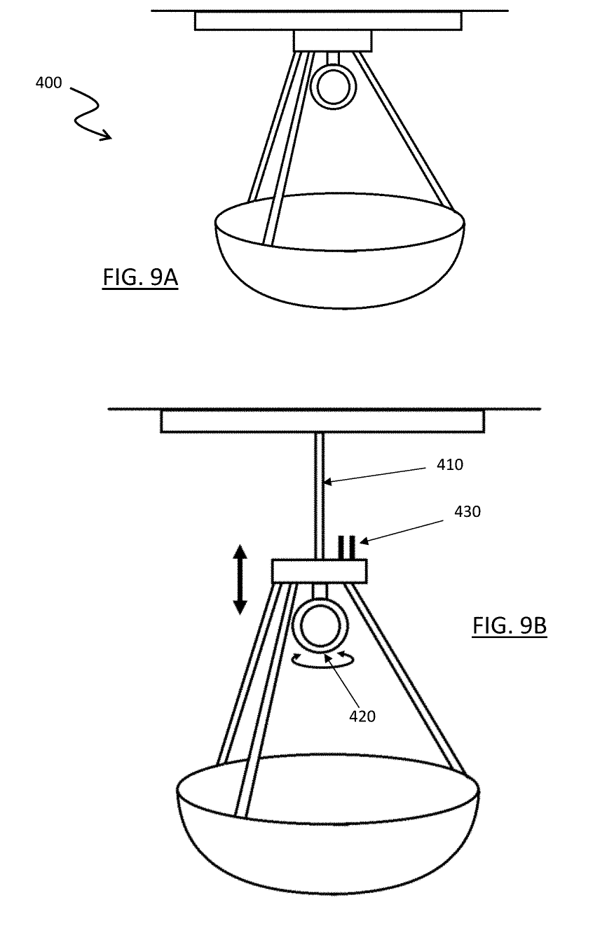

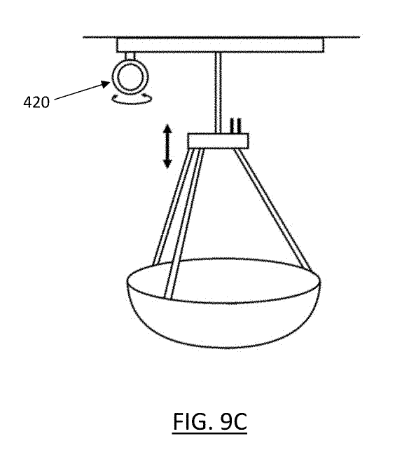

FIGS. 9A, 9B and 9C depict exemplary embodiments of a hanging basket 400 incorporating a variety of adjustability features to accommodate differing locations, installation requirements, servicing needs and/or device designs, including an ability to raise and/or lower the basket (when or if desired). Such an embodiment could be particularly useful where the basket is normally installed at a location above and/or below the normal comfortable reach of an individual. For example, a basket hanging from a high ceiling and/or over a railing or other “hard to reach” access feature may be difficult and/or dangerous to access, and/or it may be hazardous to “service” various features of the basket with the power turned on (i.e., changing a burned out light source and/or watering the plants in the basket). In such an instance, a basket design may be provided that includes an extendable cable 410 or other feature that can be raised and/or lowered remotely (i.e., using a remotely operated motor, for example) or manually operated using a hooked pole and rotating eye arrangement 420. If desired, the basket 400 can include an unplugging 430 or disengaging feature that isolates the power supply from various basket components, thereby allowing safe watering and/or access to de-energized electrical components of the basket.

Additional Advantages

Various embodiments described herein can provide a wide variety of advantages for uses of single and/or multiple hanging planter basket installations, including:

(1) The ability to minimize the mess of replanting and/or replacing the basket, when necessary;

(2) The ability to distribute and/or direct water and/or liquid plant food to one or more known locations, including the ability to confirm sufficient watering of individual planters via a single planter filling action, as well as an ability to recycle water and/or fertilizer additives for future use;

(3) The ability to provide personalized entertainment and/or music and/or “mood lighting” for an individual and/or group without disturbing nearby patrons;

(4) The ability to incorporate interchangeable light bulbs in a hanging planter basket, from white to multicolored;

(5) The ability to have a fully networked entertainment system provided in an unobtrusive hanging planter basket arrangement, including the use of color coordinated wrappings to enhance surrounding decor of person(s) using the basket(s);

(6) The ability to remove the upper tray to replant, or to maintenance the existing plants, and/or replace plants with other items such as an aquarium or other entertainment device;

(7) The ability to incorporate a variety of aesthetic items into a hanging planter basket, such as multiple colors and/or arrangements of semi-precious gemstones and/or materials; e.g. Agates, stained glass; and/or

(8) The ability to incorporate colored geodes or other minerals in a hanging planter basket to create a soft exterior colored lighting.

Other exemplary embodiments of the present invention could include incorporation of similar components and/or arrangement in hanging planter baskets, as well as various similar arrangement of components in non-planter basket devices, such as in an aquarium and/or fountain or other components in place of the plant tray (that may or may not be provided in “hanging” and/or suspended form). Desirably, such features could be provided in a modular form, which could allow various features to be “swapped out” without necessitating removal and/or replacement of the entire fixture.

For example, FIG. 2B depicts one exemplary embodiment of a modular hanging planter basket having an internal power supply (rechargeable batteries and/or broadcast power receivers, for example) and any associated electronics positioned fully within the light basket, which could then accommodate a planter tray and/or any other fitting(s) thereupon (including, for example, objects d′art, aquariums and/or terrariums). If desired, one of more of the depressions in the lower surface of the light basket component could incorporate functional devices and/or features such as solar panels (to recharge the internal batteries, for example) while other depressions could contain agates and/or other ornamental features, as desired. Such an arrangement could potentially provide a self-contained “off grid” solution for the hanging planter basket, allowing the basket it to be positioned at virtually any location within and/or outside of a business and/or residence.

The foregoing and other objects of the invention are realized with the present disclosures of preferred embodiments of the invention herein, which allows a user to use hanging planters and potted flowers in combination with lighting and entertainment apparatus. The present invention is, accordingly, more versatile, as well as more economical to produce and maintain and, therefore, more adaptable for its intended use than existing devices.

### INCORPORATION BY REFERENCE

The entire disclosure of each of the publications, patent documents, and other references referred to herein is incorporated herein by reference in its entirety for all purposes to the same extent as if each individual source were individually denoted as being incorporated by reference.

### EQUIVALENTS

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

The various headings and titles used herein are for the convenience of the reader, and should not be construed to limit or constrain any of the features or disclosures thereunder to a specific embodiment or embodiments. It should be understood that various exemplary embodiments could incorporate numerous combinations of the various advantages and/or features described, all manner of combinations of which are contemplated and expressly incorporated hereunder.

The invention may be embodied in other specific forms without departing from the spirit or essential characteristics thereof. The foregoing embodiments are therefore to be considered in all respects illustrative rather than limiting on the invention described herein. The scope of the invention is thus intended to include all changes that come within the meaning and range of equivalency of the descriptions provided herein.

Many of the aspects and advantages of the present invention may be more clearly understood and appreciated by reference to the accompanying drawings. The accompanying drawings are incorporated herein and form a part of the specification, illustrating embodiments of the present invention and together with the description, disclose the principles of the invention.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the disclosure herein.

The use of the terms “a” and “an” and “the” and similar referents in the context of describing the invention are to be construed to cover both the singular and the plural, unless otherwise indicated herein or clearly contradicted by context. The terms “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., i.e., “such as”) provided herein, is intended merely to better illuminate the invention and does not pose a limitation on the scope of the invention unless otherwise claimed. No language in the specification should be construed as indicating any non-claimed element as essential to the practice of the invention

What is claimed is:

1. A hanging basket comprising:
a wire frame basket having an upper opening, a lower opening and a plurality of peripheral openings;
a first removeable tray sized and configured to fit within the upper opening of the wire frame basket, the first tray including a downwardly oriented lower hatch positioned in proximity to the lower opening, the lower hatch openable through the lower opening to provide access to an internal structure within the first tray, the first tray further including a plurality of depressions formed in an outer surface of the first tray, at least one of the depressions aligning with at least one of the plurality of peripheral openings in the wire basket;
a second removeable tray sized and configured within the upper opening of the wire basket, the second tray including an upwardly facing generally concave surface and a lower engagement structure that engages with an upper engagement structure on an upper surface of the first tray; and
a flexible support structure extending upwardly from the wire frame basket, the flexible support structure including a plurality of flexible members.

2. The hanging basket of claim 1, wherein at least a portion of the downwardly oriented lower hatch is translucent.

3. The hanging basket of claim 1, wherein at least a portion of the downwardly oriented lower hatch is transparent.

4. The hanging basket of claim 1, further comprising an artificial light source disposed within the first removeable tray.

5. The hanging basket of claim 1, wherein at least one of the depressions includes a translucent insert positioned at least partially therein.

6. The hanging basket of claim 5, wherein the translucent insert comprises a natural stone insert.

7. The hanging basket of claim 1, wherein at least one of the depressions formed in an outer surface of the first tray further includes an opening formed through the first tray.

8. The hanging basket of claim 1, wherein the at least one of the depressions comprises a plurality of depression equally spaced around a periphery of the first removeable tray.

9. The hanging basket of claim 1, wherein at least a portion of the wire frame basket extends into at least one of the depressions formed in the outer surface of the first tray.

10. A hanging basket comprising:
a wire basket having an upper opening, a lower opening and a plurality of peripheral openings;
a first removeable tray sized and configured to fit within the upper opening of the wire basket, the first tray including a downwardly oriented lower opening positioned in proximity to the lower opening, the downwardly oriented lower opening in the first tray providing access to an internal structure positioned within the first tray, the first tray further including a plurality of openings formed through a side portion of the first tray, at least one of the plurality of openings formed through the side portion of the first tray aligning with at least one of the plurality of peripheral openings in the wire basket;
a second removeable tray sized and configured within the upper opening of the wire basket, the second tray including an upwardly extending peripheral wall; and
a flexible support structure extending upwardly from the wire frame basket, the flexible support structure including a plurality of flexible members.

11. The hanging basket of claim 10, wherein the first removeable tray further comprises an openable hatch positioned across the downwardly oriented lower opening.

12. The hanging basket of claim 10, further comprising an artificial light source disposed within the first removeable tray.

13. The hanging basket of claim 12, wherein the artificial light source is connected to an externally routed power cord, the externally routed power cord extending through an opening in the first removeable tray, along a notch formed in the second removeable tray and extending along at least one of the plurality of flexible members.

14. The hanging basket of claim 13, wherein at least one of the plurality of flexible members comprises plurality of individual links, and the externally routed power cord is weaved through the plurality of individual links.

15. The hanging basket of claim 14, wherein the at least one of the plurality of flexible members and the externally routed power cord weaved through the plurality of individual links are overlain by a flexible rope.

16. The hanging basket of claim 14, wherein at least one of the depressions formed in an outer surface of the first tray further includes an opening formed through the first tray.

17. The hanging basket of claim 16, wherein the at least one depression with an opening formed through the first tray further includes a translucent insert positioned at least partially within the depression.

18. A hanging basket comprising:
a basket having an upper opening, a lower opening and a plurality of peripheral openings;
a first removeable tray sized and configured to fit through the upper opening of the wire basket, the first tray including a downwardly oriented lower opening positioned in proximity to the lower opening of the basket, the lower opening of the first tray providing access to an internal void within the first tray, the first tray further including a plurality of openings formed through a side portion of the first tray, at least one of the plurality of openings through the side portion of the first tray aligning with at least one of the plurality of peripheral openings in the wire basket;
a second removeable tray sized and configured to pass through the upper opening of the wire basket and configured to sit on the first removeable tray; and
a flexible support structure extending upwardly from the wire frame basket, the flexible support structure including a plurality of flexible members.

19. The hanging basket of claim 18, wherein a light source is positioned within the internal void in the first tray.

20. The hanging basket of claim 19, wherein a rechargeable battery is positioned within the internal void in the first tray.
